(19) United States
(12) Patent Application Publication
(10) Pub. No.: US 2016/0082573 A1
(43) Pub. Date: Mar. 24, 2016

(54) Clamps and Clamp Components

(71) Applicant: Michael James Armstrong, Lake Clifton (AU)

(72) Inventor: Michael James Armstrong, Lake Clifton (AU)

(21) Appl. No.: 14/494,140

(22) Filed: Sep. 23, 2014

(51) Int. Cl. B25B 5/16; B25B 5/10

(52) U.S. Cl. CPC B25B 5/163; B25B 5/101

(57) ABSTRACT

In one preferred form of the present invention there is provided a clamp component 10. The component includes two portions 14 that are able to be moved relative to one another to a position in which the portions 14 receive a ball-type end 16 of a threaded shaft 18 and provide a clamping surface 20 facing away from the threaded shaft 18.

### FIELD OF THE INVENTION

The present invention relates to clamps and clamp components.

### BACKGROUND TO THE INVENTION

There are a number of clamps available on the market. One such clamp is known as the G-clamp due to the shape of the clamp representing the letter ‘G’.

Such clamps generally include a frame having two ends. A turntable threaded member generally extends through one of the ends of the frame. The other end of the frame generally provides a clamping abutment that faces an opposing clamping abutment fixed to the upper end of the threaded member.

The opposing clamping abutment generally comprises a swivel abutment in the form of a shoe. The shoe forms part of a ball joint with a ball-type end of the threaded member. The lower end of the threaded member generally comprises a grippable member that is able to be readily gripped and turned to either retract or extend the clamping abutment provided on the ball-type end of the threaded member, away from or towards the clamping abutment of the frame.

G-type and other clamps are often subject to rugged environments and difficult conditions.

It is against this background and the problems and difficulties associated therewith that the present invention has been developed. The present invention may find application with several forms of clamps.

### SUMMARY OF THE INVENTION

According to a first aspect of preferred embodiments herein described there is provided a clamp component comprising: two portions that are able to be moved relative to one another to a position in which the portions receive a ball-type end of a threaded shaft of the clamp and provide a clamping surface facing away from the threaded shaft.

Preferably the two portions each provide a recess portion for securing the ball-type end of the threaded shaft of the clamp.

Preferably the two portions are able to be brought together to form a recess having a neck portion for retaining a neck of the ball-type end.

Preferably the two portions provide respective portions of a body that provides the clamping surface facing away from the threaded shaft.

Preferably each of the two portions includes a face for being brought into a face to face relationship with the face of the other portion, each facing providing an opening on the face for receiving the ball type-end.

Preferably each portion includes at least one hole extending through the face of the portion for receiving a fastener, the fastener for holding the clamp component in position on the ball-type end.

Preferably the two portions provide respective halves of a body that provides the clamping surface facing away from the threaded shaft.

Preferably the portions comprises semicircular portions having a number of holes therein.

Preferably the clamp component comprises the shoe of a clamp.

According to a second aspect of preferred embodiments herein described there is provided a clamp component comprising: two portions; each portion providing a recess portion; the two portions being able to be joined together with the recess portions forming a recess that is able to secure the ball-type end of a threaded shaft; each of the two portions including two holes either side of the corresponding recess portion; the holes for receiving fastening elements for holding the two portions in a position in which the ball-type end of the threaded shaft is secured within the recess.

Preferably the portions each comprise a separable semicircular portion.

Preferably the two holes of each portion comprise an unthreaded hole and a threaded hole.

Preferably each portion includes a planar portion for providing a clamping surface; and each recess portion includes a first wall portion for allowing the ball-type end to be received beneath the clamping surface and an opening portion for allowing the threaded shaft to extend therefrom when the ball-type end is received therein.

Preferably the recess portions provide a centrally disposed recess when the portions are secured on the ball-type end of the threaded member.

Preferably each semicircular portion provides the recess portion between two holes extending through the corresponding semi-circular portion, the recess portions for being brought together.

Preferably the portions comprise precisely two portions.

According to a third aspect of preferred embodiments herein described there is provided clamp component comprising: a body having two portions, the portions being able to provide a first condition in which the portions are able to receive a ball-type end of a threaded shaft of the clamp and being able to be moved to a second condition in which the portions provide a recess that holds the ball-type end to secure the portions thereon.

Preferably each portion provides a body having a recess portion where the body of each portion is able to be brought together to form a recess formed from the recess portions.

Preferably the clamp component is provided as a shoe of a clamp.

It is to be recognised that other aspects, preferred forms and advantages of the present invention will be apparent from the present specification including the detailed description, drawings and claims.

### BRIEF DESCRIPTION OF DRAWINGS

In order to facilitate a better understanding of the present invention, several preferred embodiments will now be described with reference to the accompanying drawings, in which:

FIG. 1 provides a schematic exploded perspective view of a clamping component according to a first preferred embodiment of the present invention, the clamping component forming part of a clamp;

FIG. 2 provides a schematic perspective view of the clamping component and the clamp shown in FIG. 1;

FIG. 3 provides an enlarged exploded view of the clamping component shown in FIGS. 1 and 2; and

FIG. 4 provides a top cross-sectional view of the accessory shown in FIGS. 1 to 3.

### DETAILED DESCRIPTION OF THE EMBODIMENTS

It is to be appreciated that each of the embodiments is specifically described and that the present invention is not to be construed as being limited to any specific feature of any one of the embodiments. Neither is the present invention to be construed as being limited to any feature of a number of the embodiments or variations described in relation to the embodiments.

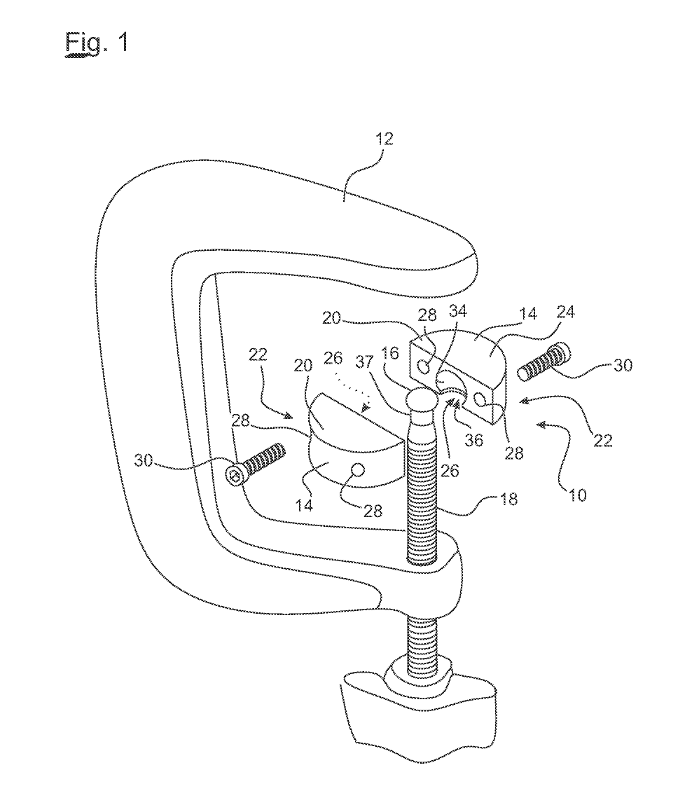

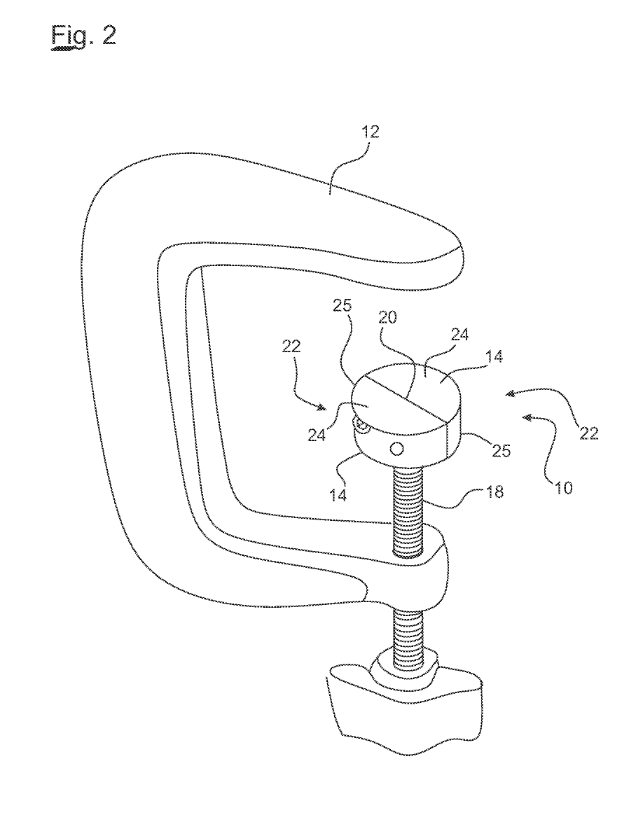

Referring to FIGS. 1 and 2 there is provided a component 10 for a clamp 12. The component 10 includes two portions 14 that are able to be moved relative to one another to a position in which the portions 14 receive a ball-type end 16 of a threaded shaft 18 of the clamp 12 and provide a clamping surface 20 facing away from the threaded shaft 18.

The portions 14 provide two halves 22 that respectively provide a corresponding clamping surface 24. The clamping surfaces 24 provide the clamping surface 20. Referring to FIG. 2, the portions 14 provide a body 25 that allows for ready clamping when secured to the shaft 18.

Returning to FIG. 1, each portion 14 provides a recess portion 26 for securing the ball-type end 16 of the threaded shaft 18. Two holes 28 are provided in each portion 14. The holes 28 of each portion 14 are positioned either side of the recess portion 26. The holes 28 extend in a perpendicular manner to the shaft 18 across the body 25. The holes 28 are able to receive fastening elements 30 forming part of the component 10. The fastening elements 30 extend through the holes 28 to hold the two portions 14 in a secured position holding the ball-type end 16 on the threaded shaft 18.

Each portion 14 includes a planar portion that makes up the clamping surface 20. Each recess portion 26 includes a first wall portion 34 for allowing the ball-type end 16 to be received beneath the clamping surface 20. Each recess portion 26 includes an opening 36 for allowing the threaded shaft 18 to extend therefrom when the ball-type end 16 is received therein.

The portions 14 are separable to provide a first condition in which the portions 14 are able to receive the ball-type end 16 of the threaded shaft 18. The portions 14 are movable to a second condition in which the portions 14 abut each other to hold the ball-type end 16 so as to be secured thereon. In operation the portions 14 are moved into position over the ball portion 16 to surround the neck portion 37 thereof.

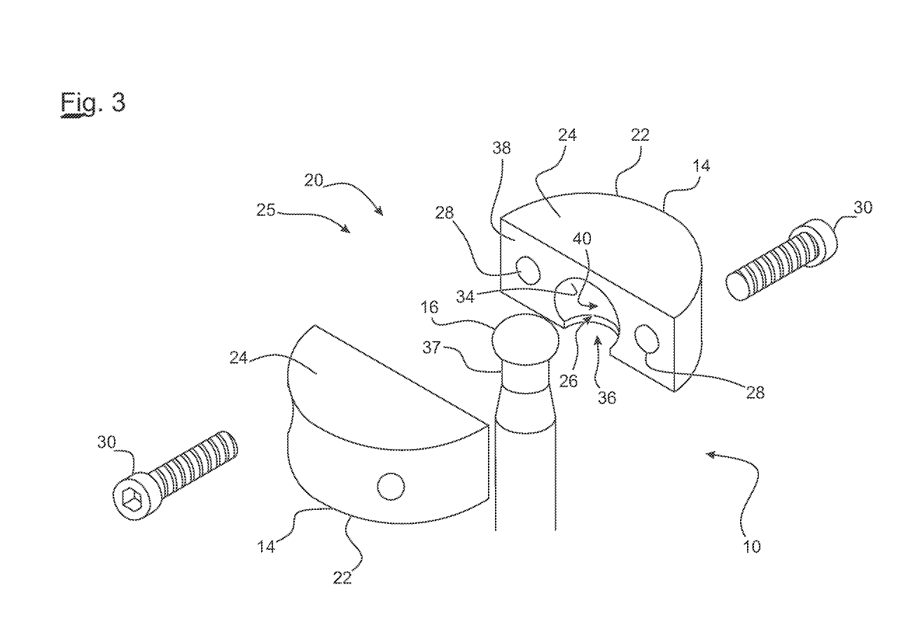

Referring to FIG. 3 each portion 14 includes a face 38 for being brought into a face to face relationship with the face 38 of the other portion 14. Each face 38 is arranged substantially perpendicular to the clamping surface 24 portion provided by the portion 14. The recess portion 36 of each portion 14 provides an opening 40, on the corresponding face 38. The opening portion 36 provides an adjoining opening that is substantially perpendicular to the opening 40. The two portions 14 are identical and provide two halves of the body 25.

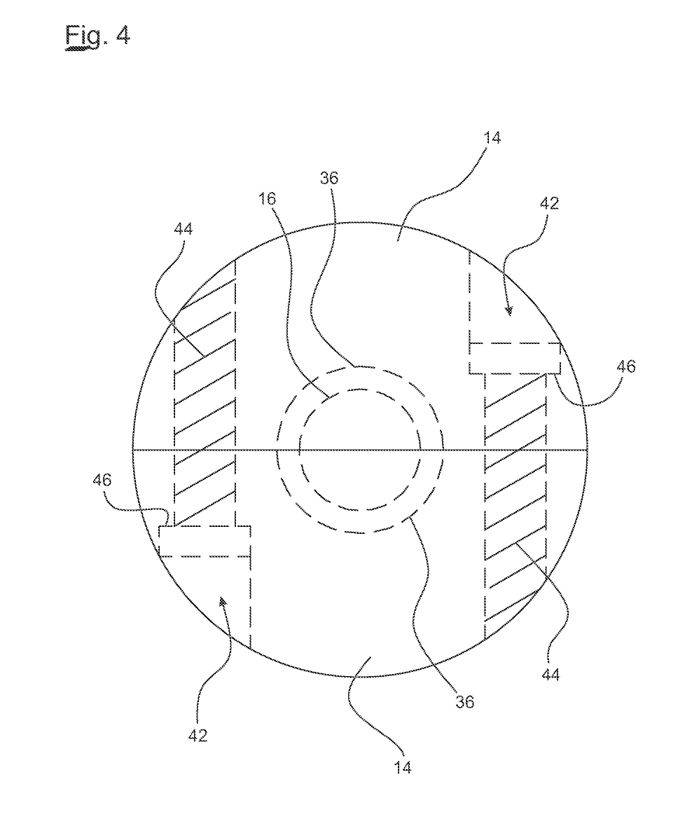

Referring to FIG. 4, the two holes 28 of each portion 14 comprise a first hole 42 and a second hole 44. The first hole 42 provides an abutment 46 for the head of a fastener and the second hole 44 provides a threaded hole. In the component 10 the first holes 42 are each aligned with a respective second hole 44 to allow the corresponding fastener n to hold the portions 14 together. The holes 28 and the fasteners 30 extend across the clamping surface 20. The holes 28 and the fasteners 30 are provided in a parallel arrangement.

The portions 14 provide a securing recess for the ball-type end 16 and have at least one fastening hole 28 extending laterally across the body 25 formed by the portions 14. More particularly, in the embodiment two such holes 28 are provided.

The portions 14 are provided as two semi-circular portions 14 that form the body 25 in a cylindrical shape. Each semi-circular portion has at least one hole 28 extending through the semi-circular portion 14 to the corresponding flat face 38 (in a direction across the cylinder). An opening extends around the centre point of the cylinder and opens inwardly to provide a ball-type joint recess. The portions 14 and the openings 36 are brought together from a separated condition to provide a narrow necked opening. The narrow necked opening is provided to hold the ball-type end in position when secured.

Another embodiment provides a method of repairing a G clamp that has lost its ‘shoe’. The portions 14 are brought together and the fastening elements 30 are secured in position to provide a secure and robust replacement. The component 10 could also could be used in new clamps. The component 10 will allow a user to readily remove and repair the clamping surface.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

The claims defining the invention are as follows:

1. A clamp component comprising: two portions that are able to be moved relative to one another to a position in which the portions receive a ball-type end of a threaded shaft of the clamp and provide a clamping surface facing away from the threaded shaft.

2. A component as claimed in claim 1 wherein the two portions each provide a recess portion for securing the ball-type end of the threaded shaft of the clamp.

3. A component as claimed in claim 1 wherein the two portions are able to be brought together to form a recess having a neck portion for retaining a neck of the ball-type end.

4. A component as claimed in claim 1 wherein the two portions provide respective portions of a body that provides the clamping surface facing away from the threaded shaft.

5. A component as claimed in claim 1 wherein each of the two portions includes a face for being brought into a face to face relationship with the face of the other portion, each facing providing an opening on the face for receiving the ball type-end.

6. A component as claimed in claim 5 wherein each portion includes at least one hole extending through the face of the portion for receiving a fastener, the fastener for holding the clamp component in position on the ball-type end.

7. A component as claimed in claim 1 wherein the two portions provide respective halves of a body that provides the clamping surface facing away from the threaded shaft.

8. A component as claimed in claim 1 wherein the portions comprises semicircular portions having a number of holes therein.

9. A component as claimed in claim 1 wherein the clamp component comprises the shoe of a clamp.

10. A clamp component comprising: two portions; each portion providing a recess portion; the two portions being able to be joined together with the recess portions forming a recess that is able to secure the ball-type end of a threaded shaft; each of the two portions including two holes either side of the corresponding recess portion; the holes for receiving fastening elements for holding the two portions in a position in which the ball-type end of the threaded shaft is secured within the recess.

11. A clamp component as claimed in claim 9 wherein the portions each comprise a separable semicircular portion.

12. A clamp component as claimed in claim 10 wherein the two holes of each portion comprise an unthreaded hole and a threaded hole.

13. A clamp component as claimed in claim 9 wherein each portion includes a planar portion for providing a clamping surface; and each recess portion includes a first wall portion for allowing the ball-type end to be received beneath the clamping surface and an opening portion for allowing the threaded shaft to extend therefrom when the ball-type end is received therein.

14. A clamp component as claimed in claim 12 wherein the recess portions provide a centrally disposed recess when the portions are secured on the ball-type end of the threaded member.

15. A clamp component as claimed in claim 13 wherein the portions comprise precisely two portions.

16. A clamp component comprising: a body having two portions, the portions being able to provide a first condition in which the portions are able to receive a ball-type end of a threaded shaft of the clamp and being able to be moved to a second condition in which the portions provide a recess that holds the ball-type end to secure the portions thereon.

17. A clamp component as claimed in claim 15 wherein each portion provides a body having a recess portion where the body of each portion is able to be brought together to form a recess formed from the recess portions.

18. A clamp component as claimed in claim 16 wherein the clamp component is provided as a shoe of a clamp.
